(19) United States
(12) Patent Application Publication
(10) Pub. No.: US 2002/0078165 A1
(43) Pub. Date: Jun. 20, 2002

(54) System and method for prefetching portions of a web page based on learned preferences

(75) Inventors: Denise M. Genty, Austin, TX (US); Gerald F. McBrearty, Austin, TX (US); Shawn P. Mullen, Buda, TX (US); Johnny M. Shieh, Austin, TX (US)

Correspondence Address: EDMOND A. DEFRANK, 20145 VIA MEDICI, NORTHRIDGE, CA, 91326, US

(73) Assignee: International Business Machines Corporation

(21) Appl. No.: 09/737,453

(22) Filed: Dec. 14, 2000

(51) Int. Cl. G06F 15/16

(52) U.S. Cl. 709/217; 709/232; 709/203

(57) ABSTRACT

A system and a method for prefetching portions of a web page based on preferences learned from previous visits to the web page. The present invention includes a smarter prefetching technique that determines whether a user prefers certain sub-pages of the web page and, if so, then prefetches these preferred sub-pages prior to the other sub-pages of the web page. The set of preferred sub-pages is generated by analyzing the user's actions during previous visits to the web page. The present invention can be customized to expand or contract its ability to “learn” user preferences. In general, the system of the present invention includes a client computer having a prefetch module that performs prefetching of the web page and a learned preferences prefetch module that instructs the prefetch module which portions of the web page to prefetch. The prefetch method of the present invention includes prefetching a set of preferred sub-pages of a web page based on learned user preferences. These learned user preferences include a history of the sub-pages of a web page that have been requested by a user, the number of days back the history should be examined and how many sub-pages within the web page are considered distinct.

### BACKGROUND OF THE INVENTION

1. Field of the Invention

The present invention relates in general to web browsers and more particularly to a system and a method for prefetching portions of a web page based on preferences learned from previous visits to the web page.

2. Related Art

The Internet, via the World Wide Web (WWW), is a graphical and interactive computer environment that is widely used for business, government, education and entertainment purposes. The World Wide Web is a system of Internet servers that support specially formatted documents (such as HyperText Markup Language (HTML)). In general, a client computer uses the Internet to access a server containing a web page. A web page is a document on the World Wide Web that supports links to other pages or sub-pages within the web page.

The client uses a web browser to locate and display web pages. In general, a browser is a software application that locates a web page using the web page's uniform resources locator (URL) that determines where on the WWW the web page is located. The web browser typically enables text, graphical and audio interaction with a web page.

One useful technique for increasing the loading time of a web page is prefetching. The idea of prefetching sub-pages of a web page is that while one sub-page is being viewed the next sub-page has already been downloaded into the client computer and browser memory cache. One problem with current prefetching techniques, however, is that they require prefetching of an entire web page. The entire web page includes all the sub-links (and thus the sub-pages) that reside on a viewed web page. Prefetching of the entire web page results in a great deal of bandwidth being wasted for all network users because many portions of the prefetched web page will never be viewed.

Accordingly, what is needed is a system and a method for prefetching a web page that is capable of prefetching only a portion of the web page. Moreover, what is needed is a prefetching system and method that prefetches a portion of a web page based on preferences learned from previous visits to the web page. What is further needed is a prefetching system and method that collects data whenever a user visits a web page regarding the preferred sub-pages of the web page.

### SUMMARY OF THE INVENTION

To overcome the limitations in the prior art as described above and other limitations that will become apparent upon reading and understanding the present specification, the present invention includes system and a method for prefetching portions of a web page based on preferences learned from previous visits to the web page. In particular, the present invention enables a smart type of prefetching to be performed. Instead of downloading all the sub-pages and sub-links of a web page, the preset invention determines the sub-pages and sub-links that the user tends to use when visiting a web page and prefetches these preferred sub-pages first. The present invention limits bandwidth waste associated with current prefetching techniques that prefetch an entire web page of sub-links regardless of user preferences and viewing history.

In general, the system of the present invention includes a client computer in communication with a server having a web page. The client includes a prefetch module that performs prefetching of the web page and a learned preferences prefetch module that instructs the prefetch module which portions of the web page to prefetch. The prefetch method of the present invention includes prefetching a portion of a web page's sub-links based on learned user preferences. In particular, the method of the present invention determines whether the prefetch option is enabled and, if so, retrieves information regarding user preferences from memory. This information includes a history of the sub-pages of a web page that have been visited, the number of days back the history should be examined and how many sub-pages within the web page are considered distinct. If the web page has been visited before, the user preference information is used to generate a unique list of sub-pages. Using this list of preferred sub-pages, the present invention prefetches only those portions of the web page that will probably be viewed by the user.

Other aspects and advantages of the present invention as well as a more complete understanding thereof will become apparent from the following detailed description, taken in conjunction with the accompanying drawings, illustrating by way of example the principles of the invention. Moreover, it is intended that the scope of the invention be limited by the claims and not by the preceding summary or the following detailed description.

### BRIEF DESCRIPTION OF THE DRAWINGS

The present invention can be further understood by reference to the following description and attached drawings that illustrate the preferred embodiments. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 illustrates a conventional hardware configuration for use with the present invention.

FIG. 2 is a block diagram of an individual computer system of FIG. 1 incorporating the present invention and is shown for illustrative purposes only.

FIG. 3 is an overview of the components of the present invention.

FIG. 4 is a flow diagram illustrating the general operation of the present invention.

FIG. 5 is a block/flow diagram illustrating a working example of the present invention.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Current prefetching techniques waste precious bandwidth by prefetching all the sub-links of an entire web page. Frequently, many sub-pages associated with these sub-links of the web page will not be viewed by a user, thus wasting bandwidth for all network users. The present invention addresses this problem by presenting a smarter prefetching technique that allows prefetching of portions of a web page. The portions of the web page to be prefetched are based on user preferences. These user preferences are obtained by analyzing user actions during previous visits to the web page and storing these user actions. The present invention reduces unnecessary bandwidth waste on downloading pages that will most likely never be viewed, while still providing a performance increase desired when using prefetching techniques. Moreover, the present invention can be customized to expand or contract its ability to “learn” user preferences.

The present invention is a smarter prefetching technique that performs an analysis when a user visits a web page. The present invention analyzes the user's history (based on previous visits to the web page) and, based on this analysis, starts prefetching the user-preferred portions of the web page. For example, if a user visits the same news web site every morning and tends to always read the articles in the categories of “politics”, “computing”, “travel” and “books”, then the present invention would determine this when the news web page was visited. Then the present invention would start downloading those articles into the browser memory before any other categories. When these preferred portions of the news web page have finished loading, the present invention can download the remainder of the categories on the news web page.

II. Exemplary Operating Environment

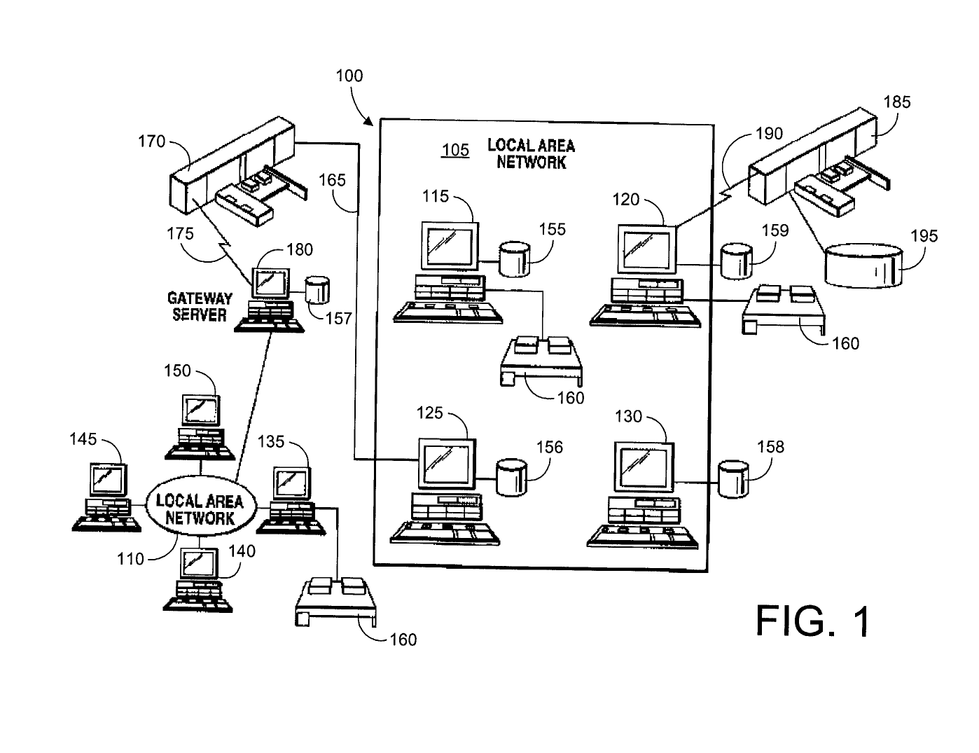

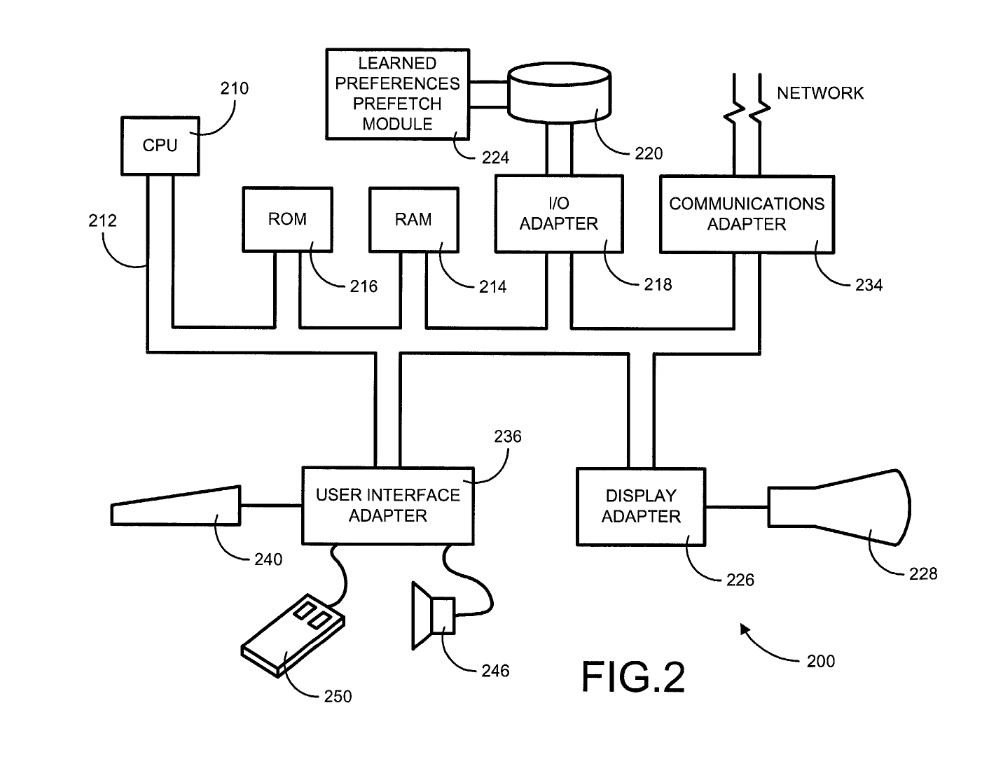

The following discussion is designed to provide a brief, general description of a suitable environment in which the present invention may be implemented. It should be noted that FIGS. 1 and 2 depict only one of several ways in which the present invention may be implemented.

FIG. 1 illustrates a conventional hardware configuration for use with the present invention. In particular, a computer system 100 may include one or more networks, such as local area networks (LANs) 105 and 110. Each of the LANs 105, 110 includes a plurality of individual computers 115, 120, 125, 130, 135, 140, 145 and 150. The computers within the LANs 105, 110 may be any suitable computer such as, for example, a personal computer made by International Business Machines (IBM) Corporation, located in Armonk, N.Y. Typically, each of the plurality of individual computers is coupled to storage devices 155, 156, 157, 158 and 159 (such as a disk drive or hard disk) that may be used to store data (such as modules of the present invention) and computer-executable instructions in accordance with the present invention. Each of the plurality of individual computers 115, 120, 125, 130, 135, 140, 145, 150 also may be coupled to an output device 160 (such as a printer) for producing tangible output. The LANs 105, 110 may be coupled via a first communication link 165 to a communication controller 170, and from the communication controller 170 through a second communication link 175 to a gateway server 180. The gateway server 180 is preferably a personal computer that serves to link the LAN 105 to the LAN 110.

The computer system 100 may also include a plurality of mainframe computers, such as a mainframe computer 185, which may be in communication with one or more of the LANs 105, 110 by means of a third communication link 190. The mainframe computer 185 is typically coupled to a storage device 195 that is capable of serving as a remote storage for one or more of the LANs 105, 110. Similar to the LANs 105, 110 discussed above, the storage device may be used to store data and computer-executable instructions in accordance with the present invention. Those skilled in the art will appreciate that the mainframe computer 185, the LAN 105 and the LAN 110 may be physically located a great distance from each other. By way of example, a user may use a client of the mainframe computer 185 to access a web page located on a server of the LAN 105. The client would then be able to view and interact with the web page on the server and, as explained in detail below, use the present invention to limit bandwidth waste.

FIG. 2 is a block diagram of an individual computer system of FIG. 1 incorporating the present invention and is shown for illustrative purposes only. A computer 200 includes any suitable central processing unit (CPU) 210, such as a standard microprocessor, and any number of other objects interconnected by a system bus 212. For purposes of illustration, the computer 200 includes memory such as random-access memory (RAM) 214, read-only memory (ROM) 216, and storage devices (such as hard disk or disk drives 220) connected to the system bus 212 by an input/output (I/O) adapter 218. The computer 200 may be a client computer that is capable of connecting and interacting with a server. Accordingly, as shown in FIG. 2, the storage device 220 may contain a learned preferences prefetch module 224 in accordance with the present invention that contains computer-executable instructions for carrying out the present invention.

The computer 200 further includes a display adapter 226 for connecting the system bus 212 to a suitable display device 228. In addition, a user interface adapter 236 is capable of connecting the system bus 212 to other user interface devices, such as a keyboard 240, a speaker 246, a mouse 250 and a touchpad (not shown). In a preferred embodiment, a graphical user interface (GUI) and an operating system (OS) reside within a computer-readable media and contain device drivers that allow one or more users to manipulate object icons and text on the display device 228. Any suitable computer-readable media may retain the GUI and OS, such as, for example, the RAM 214, ROM 216, hard disk or disk drives 220 (such as magnetic diskette, magnetic tape, CD-ROM, optical disk or other suitable storage media).

III. General Component Overview

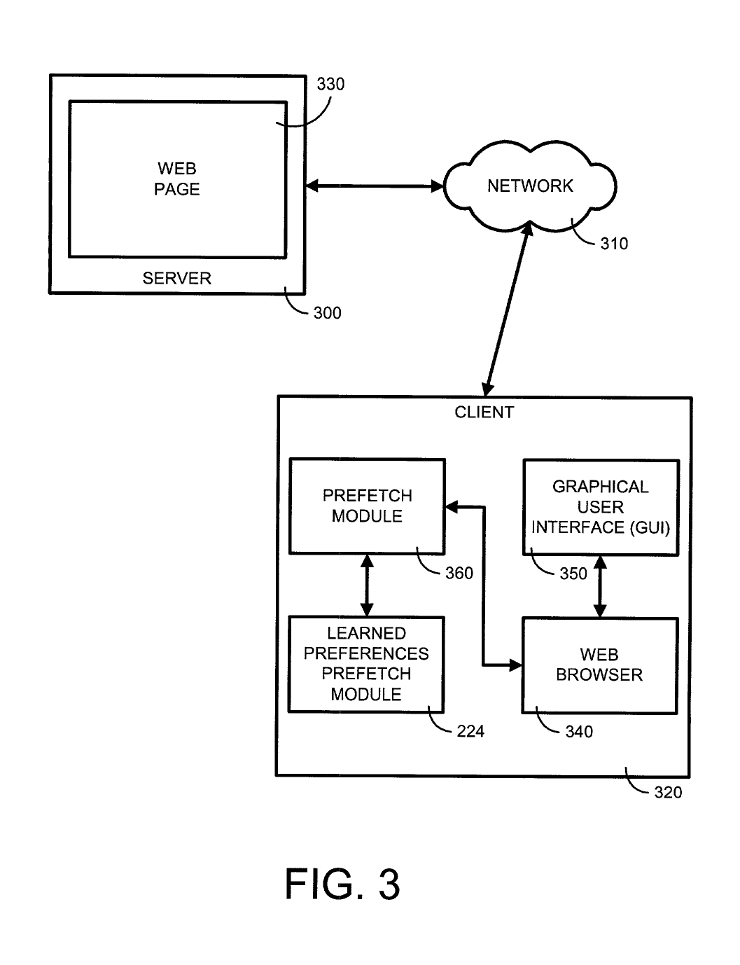

FIG. 3 is an overview of the components of the present invention, and includes a server 300 computer for communicating over a network 310 with a client 320 computer. In a preferred embodiment, the network is the Internet and the server 300 is a web server that is accessible via the Internet. The server includes a web page 330 that is a graphical interface having many sub-links. A user can access an area of interest on the web page 330 by positioning a cursor over the area of interest and clicking. This action causes the server 300 to retrieve a sub-page of the web page 330 by loading the sub-page into memory and displaying the sub-page on the client 320.

The client 320 includes a web browser 340 used to locate web pages, such as the web page 330 located on the server 300. The web browser 340 displays the web pages using a graphical user interface (GUI) 350. A prefetch module 360 prefetches a sub-page of the web page 330 from the server 300. For example, if a user is reading a set of articles on a web page about fishing and the next set of articles on the web page is about golf, the prefetch module 360 would download the set of articles about golf from the server 300 and store them in memory of the client 320. This ensures that there is little or no wait when the user is ready to read the next set of articles about golf. The client also includes a learned preferences prefetch module 224 according to the present invention. In general, the learned preference prefetch module 224 works in unison with the prefetch module 360 to ensure that only articles that the user is interested in and will actually view are prefetched.

IV. Operation and Working Example of the Invention

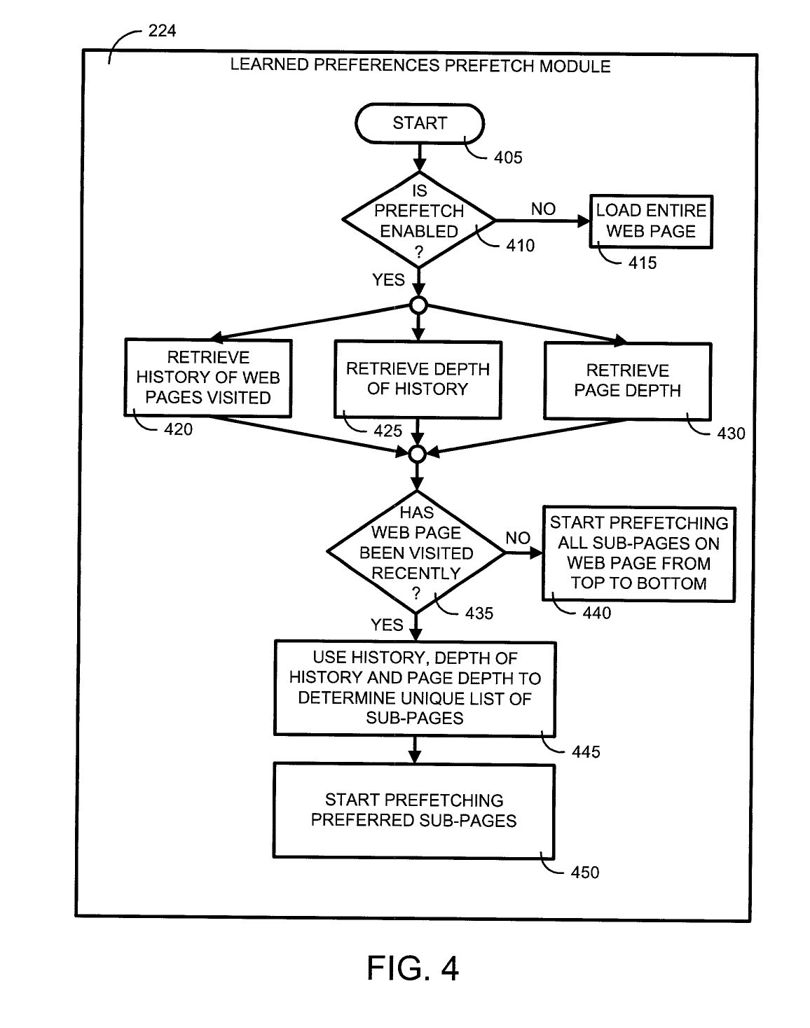

FIG. 4 is a flow diagram illustrating the general operation of the present invention. The learned preferences prefetch module 224 starts (box 405) by determining whether the prefetch capability on the client is enabled (box 410). If the prefetch capability is not enabled, the entire web page is loaded (box 415) and no prefetching is performed. If prefetching is enabled, information is retrieved from three sources. Specifically, a history of the web pages visited in retrieved (box 420), a depth of history is retrieved (box 425) and a page depth is retrieved (box 430). The history of the web pages visited is an array or list of web links that have been accessed by the browser and visited by the user. The depth of history is the length of time that is used to look back into the history of the web pages visited. The page depth is how many sub-pages with the root domain (such as the web page) should be considered distinct. In a preferred embodiment the page depth is equal to one.

The information retrieved is used to determine whether the web page being accessed has been visited recently (box 435). Preferably, the present invention determines whether the web page has been visited within the depth of history time period. If the web page has not been visited recently, then normal prefetching occurs. In other words, the normal prefetching begins whereby all the sub-links corresponding to sub-pages on the web page are prefetch in order, usually from top to bottom (box 440). If the web page has been visited recently, the history, depth of history and page depth are used to generate a unique list of sub-pages (box 445). This unique list of preferred sub-pages is used to ensure that only sub-pages that are of interest to the user are prefetched. Once the unique list has been generated, the present invention starts prefetching the preferred sub-pages (box 450).

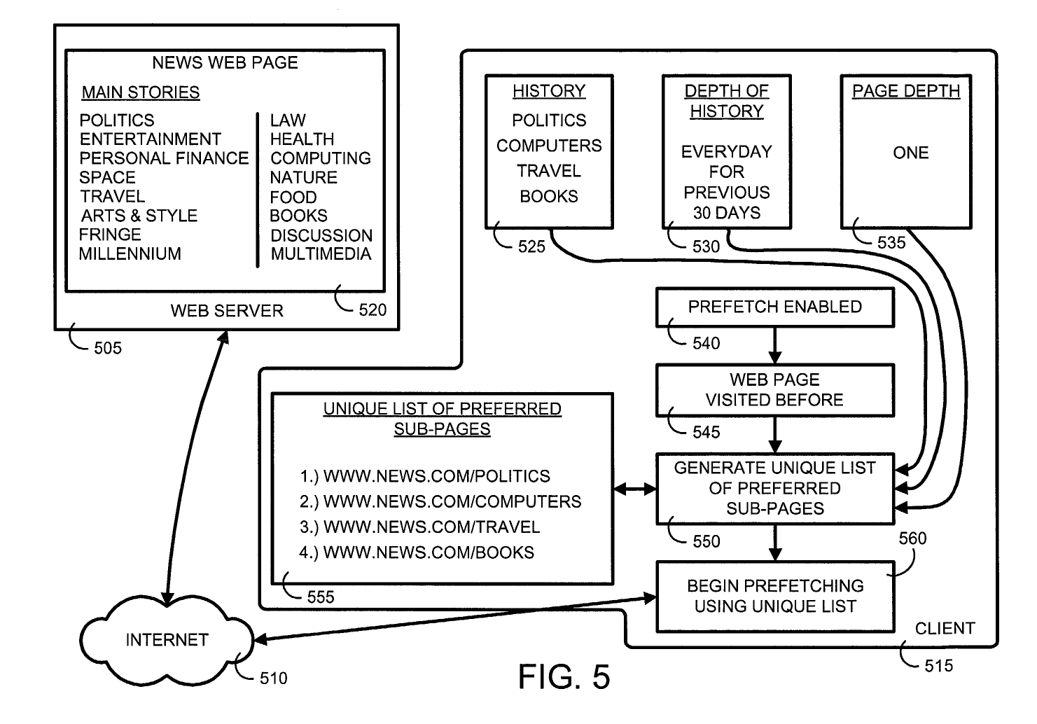

FIG. 5 is a block/flow diagram illustrating a working example of the present invention. It should be noted that the present invention may be implemented in a variety of ways and actual implementation may vary from the following description of this working example. In this working example, a web server 505 is connected to the Internet 510. Through the Internet 510, a client computer 515 connects to the web server 505 and is able to exchange information with the web server 505. The web server 505 includes a news web page 520 containing several sub-pages having headings such as politics, entertainment, personal finance, etc., as shown in FIG. 5.

The client 515 includes a history (box 525) of sub-pages visited at the news web page 520, including “politics”, “computers”, “travel” and “books”. A depth of history (box 530) is also located on the client 515 and contains the number of days previously the news web page was visited, which in this working example was everyday for the previous 30 days. A page depth (box 535) is also contained on the client 515 and includes how many sub-pages to consider distinct on the news web page 515, which in this working example is 1. This working example began by a user loading the news web page 520, just as had been done for the previous 30 days. The present invention determines that the prefetch is enabled (box 540) and that the news web page has been visited previously (box 545).

Using the information (including the history, depth of history and page depth) the present invention generates a unique list of preferred sub-pages (box 550). The list of preferred sub-pages (box 555) in this working example includes links for “politics”, “computers”, “travel” and “books” sub-pages located on the news web page 520. Once the user visits the first general news page, the prefetching of the sub-pages for “politics”, “computers”, “travel” and “books” begins in the background (box 560). Thus, by way of example, when the user chooses to view the “politics” sub-pages, those pages are already cached on the client computer waiting to be read. Then the sub-pages within the “politics” sub-pages begin their background prefetches according to the depth of history and page depth values set for this prefetch session. In this manner, the present invention limits the bandwidth associated with a background prefetch of a web page by ensuring that only those sub-pages having a high probability of being using are prefetched.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

What is claimed is:

1. A method for prefetching web pages, comprising:
determining whether an accessed web page has a set of user-preferred sub-pages from a plurality of sub-pages; and
prefetching the set of user-preferred sub-pages.

2. The method of claim 1, wherein the set of user-preferred sub-pages is based on the user's previous visits to the web page.

3. The method of claim 1, wherein prefetching the set of user-preferred sub-pages occurs in an order dependent on a number of times the user has requested each one of the set of user-preferred sub-pages.

4. The method of claim 2, wherein determining whether an accessed web page has the set of user-preferred sub-pages includes using learned user preferences including a history of the plurality of sub-pages visited by a user.

5. The method of claim 4, wherein the learned user preferences further include a depth of history that determines a number of days previously that the history is used.

6. The method of claim 5, wherein the learned user preferences further include a page depth that determines how many sub-pages within the web page are considered distinct.

7. The method of claim 1, wherein the set of user-preferred sub-pages also contains additional sub-pages and sub-links corresponding to the additional sub-pages.

8. The method of claim 1, further including generating and storing the set of user-preferred sub-pages obtained during a user's previous visits to the web page.

9. The method of claim 2, wherein the set of user-preferred sub-pages is a unique list of user-preferred sub-pages that orders the user-preferred sub-pages depending on the frequency of a user's previous visits to each of the user-preferred sub-pages.

10. The method of claim 9, wherein prefetching is performed in an order set forth in the unique list of user-preferred sub-pages.

11. A method for using a client on a computer network to request a web page from a web server, the web page having a plurality of sub-pages, the method comprising:
enabling a prefetching technique on the client such that some of the plurality of sub-pages can be retrieved and placed in a memory cache on the client;
determining that a user has preferred sub-pages from the plurality of sub-pages based on the user's prior visits to the web page; and
using the prefetching technique to prefetch the preferred sub-pages prior to any other of the plurality of sub-pages.

12. The method of claim 11, wherein the preferred sub-pages are generated using a history of which of the plurality of sub-pages a user requested during the user's prior visits.

13. The method of claim 12, wherein the preferred sub-pages are further generated using a depth of history that reflects a frequency of request by the user for each one of the plurality of sub-pages.

14. The method of claim 11, wherein the preferred sub-pages are generated using a page depth that indicates how many of the plurality of sub-pages that are considered distinct.

15. The method of claim 11, wherein the preferred sub-pages are a list of the preferred sub-pages placed in an order according to how often the user requested each one of the preferred sub-pages.

16. A learned preference prefetching system for using a client computer on a computer network to prefetch a web page having a plurality of sub-pages in response to a request by a user, comprising:
a prefetch module disposed on the client computer that allows the client computer to retrieve sub-pages of the web page; and
a learned preferences prefetch module in communication with the prefetch module that determines that the user has a set of preferred sub-pages from the plurality of sub-pages and uses the prefetch module to prefetch the set of preferred sub-pages.

17. The learned preference prefetching system of claim 16, wherein the set of preferred sub-pages is generated using learned user preferences that include a history of which of the plurality of sub-pages were previously requested by the user during the user's previous visits to the web page.

18. The learned preference prefetching system of claim 17, where the learned user preferences include a depth of history that determines a period of time over which the user has previously requested each one of the plurality of sub-pages.

19. The learned preference prefetching system of claim 16, wherein the set of preferred sub-pages is a unique list having a preferred prefetch order based on the frequency of the user's previous request of each of the set of preferred sub-pages.

20. The learned preference prefetching system of claim 19, wherein the learned preferences prefetch module uses the prefetch module to prefetch the set of preferred sub-pages in the preferred prefetch order.
